(19) United States
(12) Patent Application Publication
(10) Pub. No.: US 2015/0256845 A1
(43) Pub. Date: Sep. 10, 2015

(54) METHOD FOR PREDICTING INTER-VIEW MOTION AND METHOD FOR DETERMINING INTERVIEW MERGE CANDIDATES IN 3D VIDEO

(71) Applicant: HUMAX HOLDING CO., LTD., Yongin (KR)

(72) Inventors: Alex Chungku Yie, Incheon (KR); Yong-Jae Lee, Seoul (KR); Hui Kim, Namyangju (KR)

(21) Appl. No.: 14/432,961

(22) PCT Filed: Oct. 21, 2013
(86) PCT No.: PCT/KR2013/009373

§ 371 Date: Apr. 1, 2015

(30) Foreign Application Priority Data
Oct. 22, 2012 (KR) 10-2012-0117010
Oct. 21, 2013 (KR) 10-2013-0125013

(51) Int. Cl. H04N 19/513; H04N 13/00

(52) U.S. Cl. CPC H04N 19/513; H04N 13/0048

(57) ABSTRACT

In a method for predicting motion in a 3D multi-view video, when inter-view motion in predicting in the 3D multi-view video, a prediction motion vector with respect to a current view picture is calculated by using a motion parameter of one inter-view picture from a plurality of inter-view pictures that have been previously encoded, in order to calculate the prediction motion vector of the current view picture. As a result, complexity can be reduced by simplifying inter-view motion prediction.

### BACKGROUND OF THE INVENTION

1. Field of the invention

The present invention relates to method and apparatus for encoding 3D images, and more particularly, to a method for predicting inter-view motion and a method for determining inter-view merge candidates in a 3D video.

2. Related Art

Generally, in an image compression method, in order to increase compression efficiency, inter prediction and intra prediction techniques which remove redundancy of pictures are used.

A method of encoding an image by using the inter prediction is a method of compressing the image by removing temporal redundancy between the pictures and representatively includes a motion-compensated prediction encoding method.

In the motion-compensated prediction encoding, a region similar to a current encoded block is searched in at least one reference picture which is positioned ahead and/or behind a current encoded picture to generate a motion vector (MV), and a prediction block obtained by performing motion compensation by using the generated motion vector and a residue of a current prediction unit are discrete-cosine-transformed (DCT), quantized, entropy-encoded, and transmitted.

In the case of the motion compensation inter-view prediction, one picture is divided into a plurality of blocks having predetermined sizes to generate a motion vector (MV), and motion compensation is performed by using the generated motion vector. An individual motion parameter with respect to each prediction block obtained by performing the motion compensation is transmitted to a decoder.

In the case of a 3D image, each pixel includes pixel information and depth information due to characteristics of the image, and an encoder may calculate the depth information to transmit multi-view video information and depth information to the decoder.

Further, in the case of a multi-view image, it is necessary to efficiently reduce inter-view redundancy between a plurality of view images which is photographed by many cameras

### SUMMARY OF THE INVENTION

As such, in the case of inter-view motion prediction of a 3D multi-view image, during motion vector prediction with respect to a current view picture, a method of efficiently calculating a prediction motion vector with respect to the current view picture by using a motion parameter of a previously encoded inter-view picture is required.

The present invention has been made in an effort to provide a method for predicting inter-view motion in a 3D multi-view video for reducing complexity during inter-view motion prediction of the 3D multi-view video.

Further, the present invention has been made in an effort to provide a method for determining inter-view merge candidates during inter-view motion prediction in a 3D multi-view video having advantage of reducing complexity in the case of calculating inter-view merge candidates of a current view picture, during the inter-view motion prediction of the 3D multi-view video.

An exemplary embodiment of the present invention provides a method for predicting inter-view motion in a 3D multi-view video, in which in the case of performing inter-view motion prediction of a 3D multi-view video, a prediction motion vector with respect to the current view picture is calculated by a motion parameter of one inter-view picture among a plurality of inter-view pictures that have been previously encoded in order to calculate a prediction motion vector for a current view picture.

One inter-view picture may be any one view picture among view pictures before the current view.

One inter-view picture may be a view picture just before the current view picture.

The view picture just before the current view picture may be a picture which is temporally encoded earlier than the current view and included in a reference picture list List 0.

The prediction motion vector with respect to the current view picture may be calculated by using a motion parameter of a corresponding block of a view picture just before the current view among all inter-view pictures that are encoded earlier than the current view.

The prediction motion vector with respect to the current view picture may be calculated by using a motion parameter of one inter-view picture among a plurality of inter-view pictures that are previously encoded and a motion parameter of a neighboring block of a current block of the current view picture.

The prediction motion vector with respect to the current view picture may be calculated by using a motion parameter of one inter-view picture among a plurality of inter-view pictures that are encoded and a motion parameter of at least one neighboring block of a current block of the current view picture.

Another exemplary embodiment of the present invention provides a method for determining inter-view merge candidates in a 3D multi-view video, in which during inter-view motion prediction in the 3D multi-view video, in the case of calculating inter-view merge candidates of a current view picture, the same motion parameter as a motion parameter of a corresponding block in a temporal direction is used as the Inter-view merge candidates.

In the case of performing inter-view motion prediction of the 3D multi-view video, a prediction motion vector with respect to the current view picture may be calculated by a motion parameter of at least one inter-view picture among a plurality of inter-view pictures that have been previously encoded in order to calculate a prediction motion vector for a current view picture.

One inter-view picture may be any one view picture among view pictures before the current view.

One inter-view picture may be a view picture just before the current view picture.

The view picture just before the current view picture may be a picture which is encoded temporally earlier than the current view and included in a reference picture list List 0.

During inter-view motion prediction in the 3D multi-view video, in the case of calculating inter-view merge candidates of a current view picture, the same motion parameter as a motion parameter of a corresponding block in a temporal direction and a motion parameter of at least one neighboring block of a current block of the current view may be used as the inter-view merge candidates of the current block of the current view picture.

In the case of inter-view motion prediction of a 3D multi-view video, the prediction motion vector with respect to the current view picture is calculated by a motion parameter of one inter-view picture among a plurality of inter-view pictures that have been previously encoded in order to calculate a prediction motion vector with respect to a current view picture. As a result, complexity can be reduced by simplifying inter-view motion prediction.

Further, in the case of inter-view motion prediction of a 3D multi-view video, the prediction motion vector with respect to the current view picture is calculated by a motion parameter of one inter-view picture among a plurality of inter-view pictures that have been previously encoded and a motion parameter of a neighboring block of a current block, in order to calculate a prediction motion vector with respect to a current view picture. As a result, accuracy of the inter-view motion prediction can be improved as compared with the case of calculating the prediction motion vector with respect to the current view picture by a motion parameter of one inter-view picture among a plurality of inter-view pictures that have been previously encoded.

Further, during the inter-view motion prediction of a 3D multi-view video, inter-view merge candidates of a current view picture are calculated by using the same motion parameters as motion parameters (a prediction direction, reference pictures, and a motion vector) of a corresponding block in a temporal direction as the Inter-view merge candidates. As a result, complexity can be reduced by simplifying inter-view motion prediction.

Further, during the inter-view motion prediction of a 3D multi-view video, inter-view merge candidates of a current block of a current view picture are calculated by using the same motion parameters as motion parameters (a prediction direction, reference pictures, and a motion vector) of a corresponding block in a temporal direction and a motion parameter of a neighboring block(s) of a current block of a current view, in order to calculate inter-view merge candidates of a current view picture. As a result, accuracy of the inter-view motion prediction can be improved as compared with the case of using the same motion parameters as motion parameters (a prediction direction, reference pictures, and a motion vector) of a corresponding block in a temporal direction as the Inter-view merge candidates.

### BRIEF DESCRIPTION OF THE DRAWINGS

FIG. 1 is a schematic diagram for describing a process of calculating a prediction motion vector with respect to a current view picture by using a plurality of inter-view pictures in the case of inter-view motion prediction of a 3D multi-view video.

FIGS. 2A and 2B are a schematic diagram illustrating a neighboring block of a current block.

FIG. 3 is a schematic diagram for describing a process of calculating a prediction motion vector with respect to a current view picture by using one inter-view picture that is previously encoded in the case of inter-view motion prediction of a 3D multi-view video.

### DESCRIPTION OF EXEMPLARY EMBODIMENTS

The present invention may have various modifications and various exemplary embodiments and specific exemplary embodiments will be illustrated in the drawings and described in detail.

However, this does not limit the present invention within specific exemplary embodiments, and it should be understood that the present invention covers all the modifications, equivalents and replacements within the idea and technical scope of the present invention.

Terms such as first or second may be used to describe various components but the components are not limited by the above terminologies. The above terminologies are used only to discriminate one component from the other component. For example, without departing from the scope of the present invention, a first component may be referred to as a second component, and similarly, a second component may be referred to as a first component. A terminology such as and/or includes a combination of a plurality of associated items or any item of the plurality of associated items.

It should be understood that, when it is described that an element is “coupled” or “connected” to another element, the element may be “directly coupled” or “directly connected” to the another element or “coupled” or “connected” to the another element through a third element. In contrast, it should be understood that, when it is described that an element is “directly coupled” or “directly connected” to another element, it is understood that no element is not present between the element and the another element.

Terms used in the present application are used only to describe specific exemplary embodiments, and are not intended to limit the present invention. A singular form may include a plural form if there is no clearly opposite meaning in the context. In the present application, it should be understood that term “include” indicates that a feature, a number, a step, an operation, a component, a part or the combination thereof described in the specification is present, but does not exclude a possibility of presence or addition of one or more other features, numbers, steps, operations, components, parts or combinations, in advance.

If it is not contrarily defined, all terms used herein including technological or scientific terms have the same meaning as those generally understood by a person with ordinary skill in the art. Terms which are defined in a generally used dictionary should be interpreted to have the same meaning as the meaning in the context of the related art but are not interpreted as an ideally or excessively formal meaning if it is not clearly defined in the present invention.

Hereinafter, preferable exemplary embodiment of the present invention will be described in more detail with reference to the accompanying drawings. In describing the present invention, like reference numerals refer to like elements for easy overall understanding and a duplicated description of like elements will be omitted.

Hereinafter, a coding unit (CU) has a square pixel size, and may have a variable size of 2N2N (unit: pixel). The CU may have a recursive coding unit structure. Inter prediction, intra prediction, transform, quantization, deblocking filtering, and entropy encoding may be configured by a CU unit.

A prediction unit (PU) is a basic unit for performing the inter prediction or the intra prediction.

Hereinafter, a block may include the CU or the PU.

In the case of inter-view motion prediction of a 3D multi-view video, a prediction motion vector with respect to a current view picture may be calculated by using motion parameters (for example, a prediction direction, reference pictures, and a motion vector) of a plurality of inter-view pictures that are previously encoded. That is, during the inter-view motion prediction with respect to a current block, in the case of using motion data of corresponding blocks within all inter-view pictures that are previously encoded, during the motion prediction, complexity is increased.

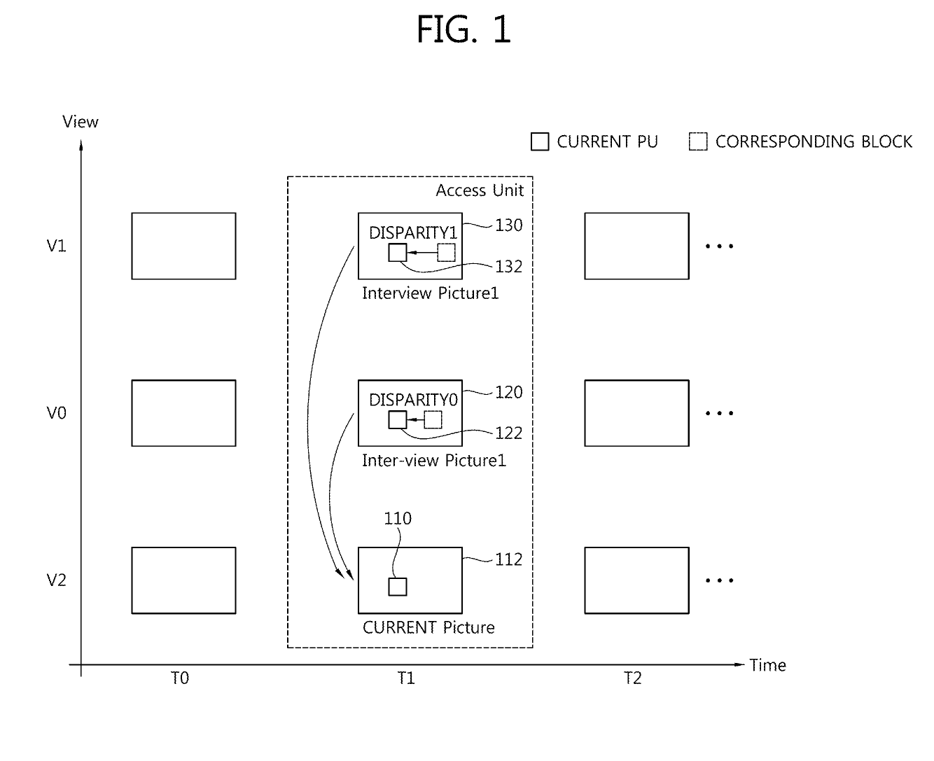

FIG. 1 is a schematic diagram for describing a process of calculating a prediction motion vector with respect to a current view picture by using a plurality of inter-view pictures in the case of inter-view motion prediction of a 3D multi-view video. FIG. 1 illustrates a case where a view coding order is in the order of V0, V1, and V2 and a case where a current V2 view picture 112 is coded.

Referring to FIG. 1, in order to calculate a prediction motion vector with respect to a current block 110 in a current V2 view picture 112, motion data of corresponding blocks of all inter-view pictures that are previously encoded, that is, a corresponding block 122 of a V0 view picture 120 and a corresponding block 132 of a V1 view picture 130 need to be stored, and in the case of using the motion data of the corresponding blocks of all of the inter-view pictures that are previously encoded, complexity of the motion prediction is increased.

Particularly, in the case of FIG. 1, even when the view picture of any one of the views V0 and V1 that are previously encoded—for example, the V1 view—is not included in a reference picture list of the current picture, motion data of the corresponding block of the corresponding view—here, V1—picture are stored.

As described above, in the case of calculating the prediction motion vector with respect to the current view picture by using the motion parameter of the plurality of inter-view pictures that are previously encoded, accuracy of the motion prediction may be increased, but complexity of the motion prediction is increased.

In the exemplary embodiment of the present invention, in the case of inter-view motion prediction of a 3D multi-view video, the prediction motion vector with respect to the current view picture may be calculated by a motion parameter of one inter-view picture among a plurality of inter-view pictures that have been previously encoded in order to calculate a prediction motion vector for a current view picture. One inter-view picture may be any one view picture among view pictures before the current view. For example, one inter-view picture may become a view picture just before the current view picture.

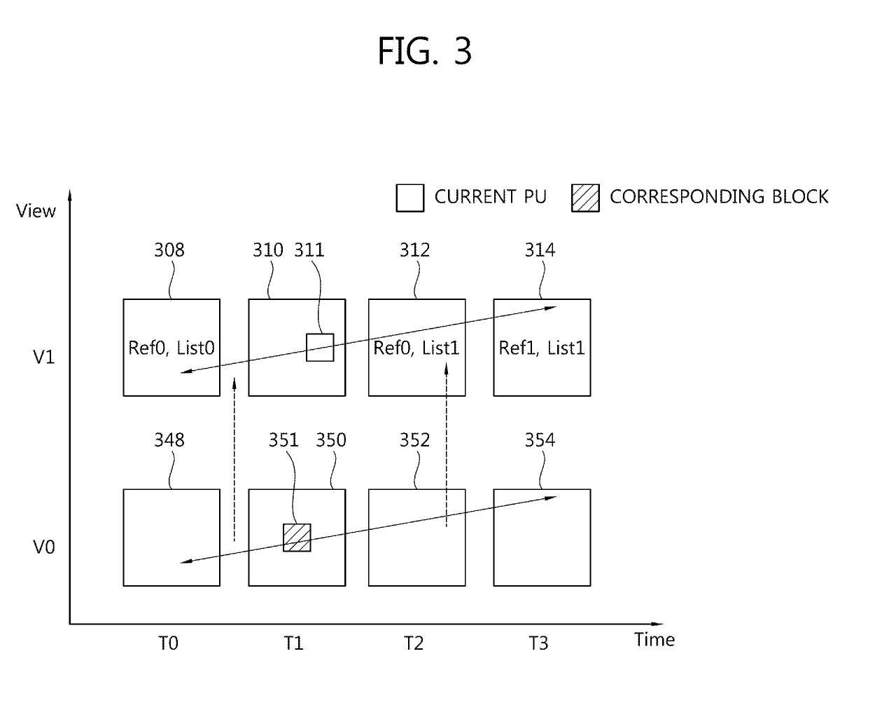

FIG. 3 is a schematic diagram for describing a process of calculating a prediction motion vector with respect to a current view picture by using one inter-view picture that is previously encoded in the case of inter-view motion prediction of a 3D multi-view video. FIG. 1 illustrates a case where a coding order is in the order of V0, V1, V2 (not illustrated), V3 (not illustrated), . . . , and a case where a current V1 view picture 310 is coded, and a picture 308 which is encoded temporally earlier than the current view V1 is included in a reference picture list List 0 as a reference picture ref0, and a picture 308 which is encoded temporally later than the current view V1 is included in a reference picture list List 1 as the reference pictures rem and ref1.

Referring to FIG. 3, in order to calculate the prediction motion vector with respect to the current block 312 in the current V1 view picture 310, a motion parameter of a corresponding block 352 of the VO view picture 350 which is the view just before the current view among all of the inter-view pictures that are previously encoded.

According to another exemplary embodiment of the present invention, in the case of inter-view motion prediction of a 3D multi-view video, the prediction motion vector with respect to the current view picture may be calculated by a motion parameter of one inter-view picture among a plurality of inter-view pictures that have been previously encoded and a motion picture of a neighboring block of the current block in order to calculate a prediction motion vector for a current view picture.

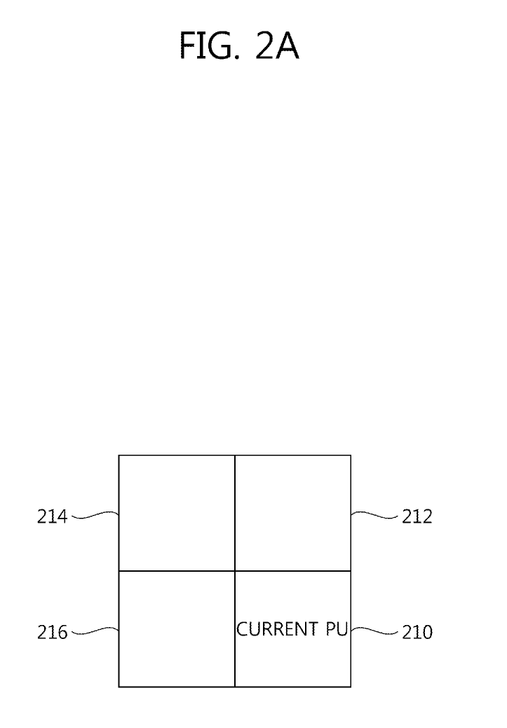

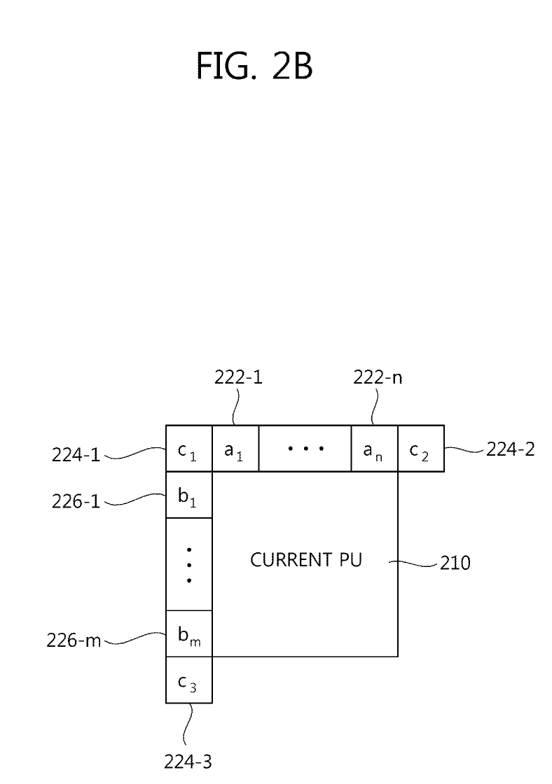

FIGS. 2A and 2B are schematic diagrams illustrating a neighboring block of a current block.

Referring to FIG. 2A, neighboring blocks of a current block 210 may include a left neighboring block 216 positioned at a left side of the current block 210, an upper neighboring block 212 positioned at an upper side of the current block 210, and an upper left neighboring block 214 positioned at an upper left side of the current block 210.

Referring to FIG. 2B, the neighboring blocks of a current block 210 may include left neighboring blocks b1(226-1), . . . , bm(226-m) positioned at a left side of the current block 210, upper neighboring blocks al(222-1), . . . , an(222-n) positioned at an upper side of the current block 210, an upper left neighboring block 224-1 positioned at an upper left side of the current block 210, a lower left neighboring block 224-3 positioned at a lower left side of the current block 210, and an upper right neighboring block 224-2 positioned at an upper right side of the current block 210.

A median value or an average value of the motion vectors of the neighboring blocks may be used to calculate the prediction motion vector with respect to the current block of the current view picture together with the motion parameter of one inter-view picture among the plurality of inter-view pictures that are previously encoded. Alternatively, motion vectors of some neighboring blocks among the neighboring blocks may also be used to calculate the prediction motion vector with respect to the current block of the current view picture together with the motion parameter of one inter-view picture among the plurality of inter-view pictures that are previously encoded.

That is, in another exemplary embodiment of the present invention, the prediction motion vector with respect to the current block of the current view picture may be calculated by using the motion parameter of one inter-view picture among the plurality of inter-view pictures that are previously encoded and the motion parameter of the neighboring block(s) of the current block described above.

Meanwhile, during the inter-view motion prediction of the 3D multi-view video, in the case of calculating inter-view merge candidates of a current view picture, the same motion parameters as motion parameters (a prediction direction, reference pictures, and a motion vector) of a corresponding block in a temporal direction may be used as the Inter-view merge candidates.

During the inter-view motion prediction of the 3D multi-view video, in the case of calculating inter-view merge candidates of a current view picture, the inter-view merge candidates of a current view picture may be calculated by using the same motion parameters as motion parameters (a prediction direction, reference pictures, and a motion vector) of a corresponding block in a temporal direction and the motion parameter of the neighboring block(s) of the current block of the current view.

While the invention has been shown and described with respect to the preferred embodiments, it will be understood by those skilled in the art that various changes and modifications may be made without departing from the spirit and scope of the invention as defined in the following claims.

What is claimed is:

1. A method for predicting inter-view motion in a 3D multi-view video, wherein in the case of performing inter-view motion prediction of a 3D multi-view video, a prediction motion vector with respect to a current view picture is calculated by a motion parameter of one inter-view picture among a plurality of inter-view pictures that have been previously encoded in order to calculate a prediction motion vector for the current view picture.

2. The method of claim 1, wherein one inter-view picture is any one view picture among view pictures before the current view.

3. The method of claim 2, wherein one inter-view picture is a view picture just before the current view picture.

4. The method of claim 3, wherein the view picture just before the current view picture is a picture which is encoded temporally earlier than the current view and included in a reference picture list List 0.

5. The method of claim 1, wherein the prediction motion vector with respect to the current view picture is calculated by using a motion parameter of a corresponding block of a view picture just before the current view among all inter-view pictures that are encoded earlier than the current view.

6. The method of claim 1, wherein the prediction motion vector with respect to the current view picture is calculated by using a motion parameter of one inter-view picture among a plurality of inter-view pictures that are previously encoded and a motion parameter of a neighboring block of a current block of the current view picture.

7. The method of claim 1, wherein the prediction motion vector with respect to the current view picture is calculated by using a motion parameter of one inter-view picture among a plurality of inter-view pictures that are encoded and a motion parameter of at least one neighboring block of a current block of the current view picture.

8. A method for determining inter-view merge candidates in a 3D multi-view video, wherein during inter-view motion prediction in the 3D multi-view video, in the case of calculating inter-view merge candidates of a current view picture, the same motion parameter as a motion parameter of a corresponding block in a temporal direction is used as the Inter-view merge candidates.

9. The method of claim 8, wherein in the case of performing inter-view motion prediction of the 3D multi-view video, a prediction motion vector with respect to the current view picture is calculated by a motion parameter of at least one inter-view picture among a plurality of inter-view pictures that have been previously encoded in order to calculate a prediction motion vector for a current view picture.

10. The method of claim 9, wherein one inter-view picture is any one view picture among view pictures before the current view.

11. The method of claim 10, wherein one inter-view picture is any one view picture just before the current view picture.

12. The method of claim 11, wherein the view picture just before the current view picture is a picture which is encoded temporally earlier than the current view and included in a reference picture list List 0.

13. The method of claim 8, wherein during inter-view motion prediction in the 3D multi-view video, in the case of calculating inter-view merge candidates of a current view picture, the same motion parameter as a motion parameter of a corresponding block in a temporal direction and a motion parameter of at least one neighboring block of a current block of the current view are used as the inter-view merge candidates of the current block of the current view picture.
